(19) United States
(12) Patent Application Publication
(10) Pub. No.: US 2011/0080957 A1
(43) Pub. Date: Apr. 7, 2011

(54) ENCODING ADAPTIVE DEBLOCKING FILTER METHODS FOR USE THEREWITH

(75) Inventors: Feng Pan, Richmond Hill (CA); Yang Liu, Richmond Hill (CA)

(73) Assignee: VIXS SYSTEMS, INC., Toronto (CA)

(21) Appl. No.: 12/574,804

(22) Filed: Oct. 7, 2009

(51) Int. Cl. H04N 7/26

(52) U.S. Cl. 375/240.24; 375/E07.029

(57) ABSTRACT

A video filter includes a filter parameter generator receives a non-quantization coding parameter corresponding to video data and generates a plurality of deblocking filter parameters in response thereto. An adaptive deblocking filter filters the video data to generate processed video data, based on the plurality of deblocking filter parameters.

### CROSS REFERENCE TO RELATED PATENTS

NOT APPLICABLE

### TECHNICAL FIELD OF THE INVENTION

The present invention relates to deblocking filters used in video processing.

### DESCRIPTION OF RELATED ART

Video encoding has become an important issue for modern video processing devices. Robust encoding algorithms allow video signals to be transmitted with reduced bandwidth and stored in less memory. However, the accuracy of these encoding methods face the scrutiny of users that are becoming accustomed to greater resolution and higher picture quality. Standards have been promulgated for many encoding methods including the H.264 standard that is also referred to as MPEG-4, part 10 or Advanced Video Coding, (AVC). While this standard sets forth many powerful techniques, further improvements are possible to improve the performance and speed of implementation of such methods. The video signal encoded by these encoding methods must be similarly decoded for playback on most video display devices.

Block-based coding, such as Moving Picture Experts Group (MPEG) coding introduces blocking artifacts between block boundaries. The reason is that the transform does not consider the correlation between block boundaries when blocks are independently coded. As result, the boundary area belonging to different blocks may be differently processed in the quantization step creating visual artifacts. The severity of these artifacts depends on different level of compression. In general, the lower the bit rate of a video stream, the severer the potential artifacts. A deblocking filter strives to reduce the severity of these artifacts.

The limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIGS. 1-3 present pictorial diagram representations of various video devices in accordance with embodiments of the present invention.

FIG. 4 presents a block diagram representation of a video system in accordance with an embodiment of the present invention.

FIG. 5 presents a block diagram representation of a video filter 102 in accordance with an embodiment of the present invention.

FIG. 6 presents a block diagram representation of a filter parameter generator 40 in accordance with an embodiment of the present invention.

FIG. 7 presents a block flow diagram of a video encoding operation in accordance with an embodiment of the present invention.

FIG. 8 presents a block flow diagram of a video decoding operation in accordance with an embodiment of the present invention.

FIG. 9 presents a flowchart representation of a method in accordance with an embodiment of the present invention.

### DETAILED DESCRIPTION OF THE INVENTION INCLUDING THE PRESENTLY PREFERRED EMBODIMENTS

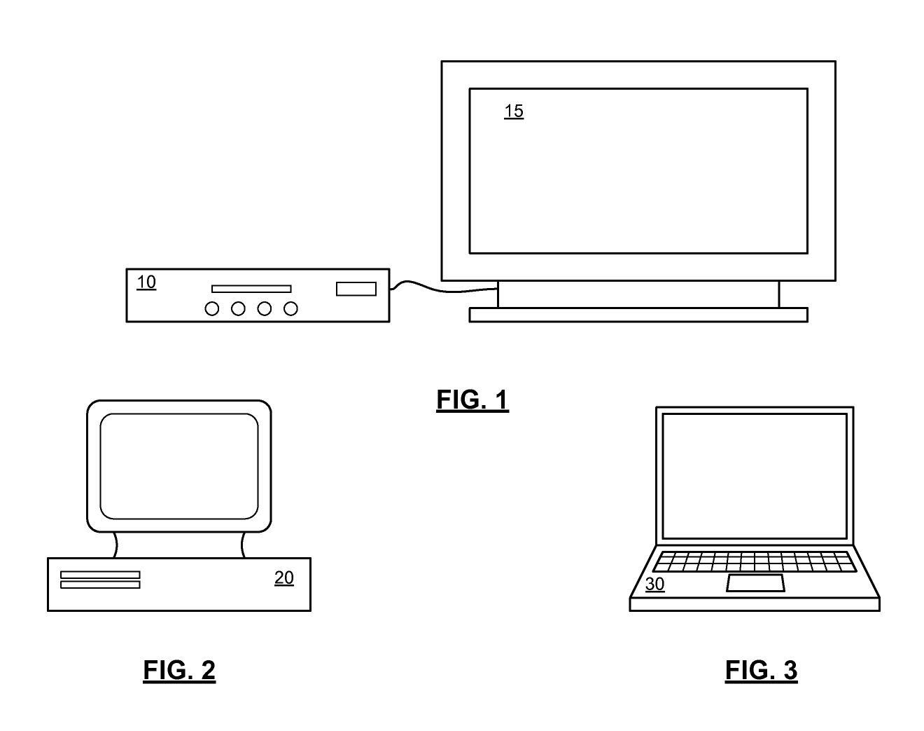

FIGS. 1-3 present pictorial diagram representations of various video devices in accordance with embodiments of the present invention. In particular, set top box 10 with built-in digital video recorder functionality or a stand alone digital video recorder, television or monitor 15, computer 20 and portable computer 30 illustrate electronic devices that incorporate a video device that includes one or more features or functions of the present invention. While these particular devices are illustrated, the video device of the present invention includes any device that is capable of filtering video content in accordance with the methods and systems described in conjunction with FIGS. 4-9 and the appended claims.

FIG. 4 presents a block diagram representation of a video device in accordance with an embodiment of the present invention. In particular, this video device includes a receiving module 100, such as a television receiver, cable television receiver, satellite broadcast receiver, broadband modem, 3G transceiver, network connection or other information receiver or transceiver that is capable of receiving a received signal 98 and extracting one or more video signals 110 via time division demultiplexing, frequency division demultiplexing or other demultiplexing technique. Video processing device 125 is coupled to the receiving module 100 to encode, transcode or decode the video signal 110 for storage, editing, and/or playback in a format corresponding to video display device 104. Video processing device 125 includes video filter 102 that processes video data to produce processed video data as a part of the encoding, decoding or transcoding of the video signal 110.

In an embodiment of the present invention, the received signal 98 is a broadcast video signal, such as a television signal, high definition television signal, enhanced definition television signal or other broadcast video signal that has been transmitted over a wireless medium, either directly or through one or more satellites or other relay stations or through a cable network, optical network or other transmission network. In addition, received signal 98 can be generated from a stored video file, played back from a recording medium such as a magnetic tape, magnetic disk or optical disk, and can include a streaming video signal that is transmitted over a public or private network such as a local area network, wide area network, metropolitan area network or the Internet.

Video signal 110 can include a digital video signal that has been coded in compliance with a digital video codec standard such as a Movings Picture Experts Group (MPEG) format (such as MPEG1, MPEG2 or MPEG4), Quicktime format, Real Media format, Windows Media Video (WMV), or Audio Video Interleave (AVI), etc. and is being post process filtered by video filter 102 to reduce or eliminate blocking artifacts introduced by this coding. Further, video signals 110 can include analog video signals that are formatted in any of a number of video formats including National Television Systems Committee (NTSC), Phase Alternating Line (PAL) or Sequentiel Couleur Avec Memoire (SECAM).

Video display devices 104 can include a television, monitor, computer, handheld device or other video display device that creates an optical image stream either directly or indirectly, such as by projection, based on the display or further decoding the processed video signal 112 either as a streaming video signal or by playback of a stored digital video file.

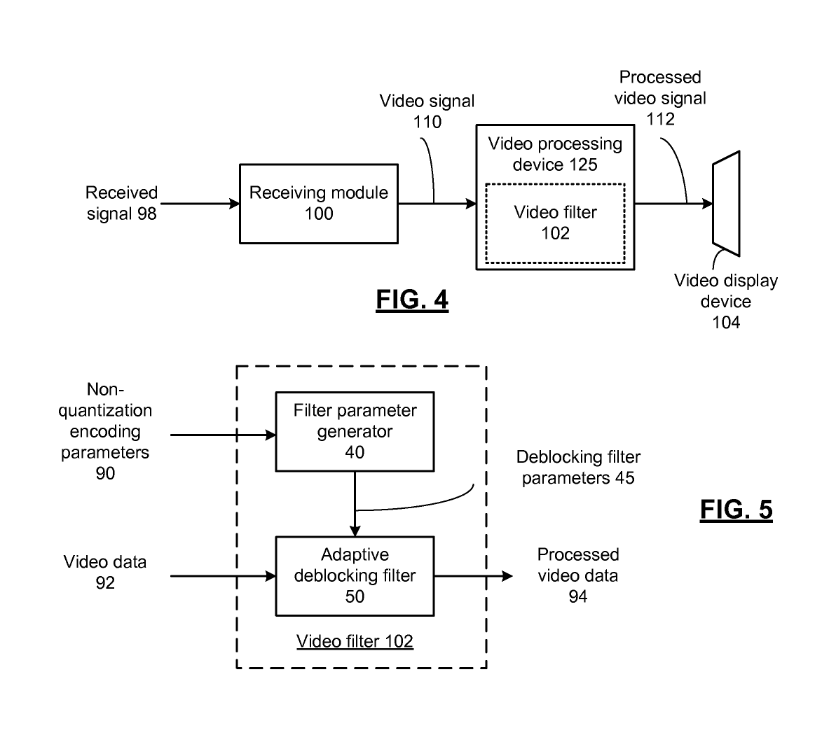

In accordance with an embodiment the present invention, the video filter 102 includes an encoding adaptive deblocking filter in accordance with many optional functions and features described in conjunction with FIGS. 5-9 that follow.

FIG. 5 presents a block diagram representation of a video filter 102 in accordance with an embodiment of the present invention. In particular, a video filter 102 is shown as described in conjunction with FIG. 4. Adaptive blocking filter 50 generates processed video data 94 by filtering video data 92.

In an embodiment of the present invention, adaptive deblocking filter 50 is a deblocking filter that operates in accordance with the H.264/AVC specification to reduce blocking distortion on a coded and reconstructed video frame as part of an encoding, decoding or transcoding performed in conjunction with the H.264 standard or similar processing. In particular, the filtering video data 92 can be used in conjunction with motion compensation for further video frames. In operation, the deblocking filter 50 operates to smooth horizontal and vertical edges of a block that may correspond to exterior boundaries of a macroblock of a frame or field of video data 92 or edges that occur in the interior of a macroblock. A boundary strength, that is determined based on quantization parameters, adjacent macroblock type, etcetera, can vary the amount of filtering to be performed. In addition, the H.264 standard defines two parameters, α and β, that are used to determine the strength of filtering on a particular edge. α is a boundary edge parameter applied to data that includes macroblock boundaries. β is an interior edge parameter applied to data that within a macroblock interior.

According to the H.264 standard, α and β are selected as integers within the range [−6, 6] based on the average of the quantization parameters, QP, of the two blocks adjacent to the edge. In particular, α and β are increased for large values of QP and decreased for smaller values of QP. In accordance with the present invention however, non-quantization coding parameters 90 are used by filter parameter generator 40 to determine deblocking filter parameters 45 such as values for α and β. For instance, α and β can be varied simultaneously based on the non-quantization coding parameters 90. In some embodiments, α and β can be varied independently.

While video filter 102 is described above for use in conjunction with encoding, decoding or transcoding performed in conjunction with the H.264 standard, the techniques of the present invention can be applied to the adjustment of other deblocking filter parameters 45 such as other thresholds based on non-quantization coding parameters 90 and further to other deblocking filter parameters 45 corresponding to other filter configurations used in conjunction with other encoding, decoding or transcoding of a video data, such as video data 92.

Filter parameter generator 40 and adaptive deblocking filter 50 can be implemented using a single processing device, a shared processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory. Such a memory may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

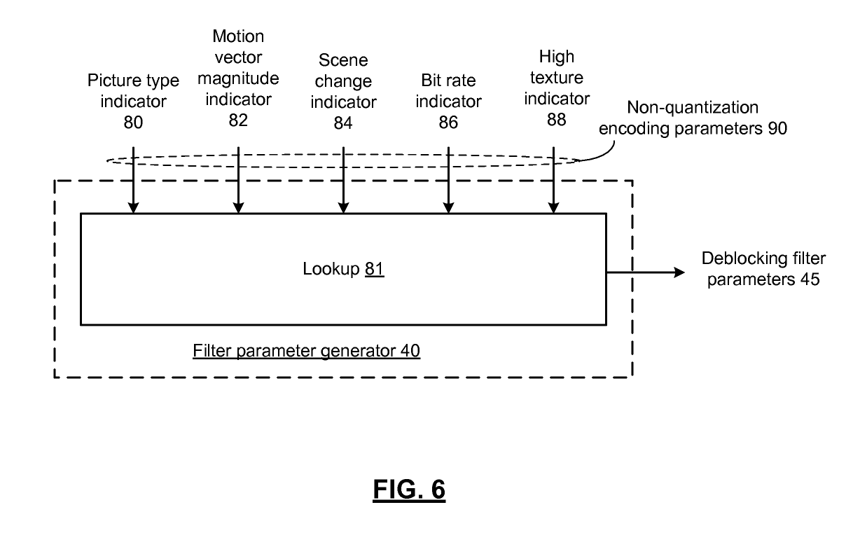

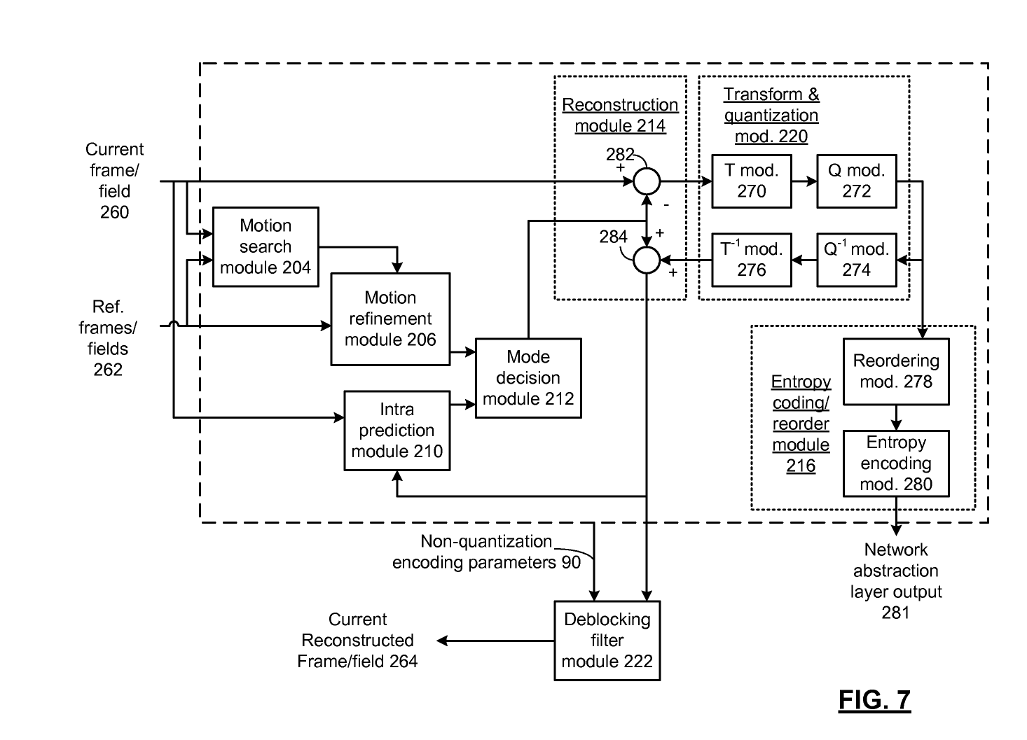

FIG. 6 presents a block diagram representation of a filter parameter generator 40 in accordance with an embodiment of the present invention. In particular a filter parameter generator 40 is shown that includes a lookup 81, such as a lookup table or other logic device that generates deblocking filter parameters based on one or more of the picture indicator 80, motion vector magnitude indicator 82, scene change indicator 84 and/or bit rate indicator 86. As discussed in conjunction with FIG. 5, the deblocking filter parameters 45 can correspond to values of α and β.

In an embodiment of the present invention, picture type indicator 80 can indicate a picture type, such as whether the video data 92 corresponds to an I picture, B picture or P picture. The value of α/β can be selected based on the picture indicator. For example, the value of α/β can be selected to larger values of α/β for B pictures, medium values of α/β for P pictures and smaller values of α/β for I pictures. Further, the values of α and β can selected or further adjusted based on other conditions indicated by other non-quantization coding parameters 90. When motion vector magnitude indicator 82 indicates large motion vectors in video data 92, a larger value of α can be selected. Further, when motion vector magnitude indicator 82 indicates small motion vectors in video data 92, a smaller value of α can be selected. When scene change indicator 84 indicates a change in scene in video data 92, a high value of α can be selected. When bit rate indicator 86 indicates a high bit rate, a smaller value of α can be selected. Further when high texture indicator 88 indicates a high texture in video data 92, a smaller value of β can be selected.

In an embodiment of the present invention, the lookup 81 includes additional processing via one or more comparators or other logic for comparing the values of one or more of the non-quantization coding parameters 90 generated in encoding or decoding to their own thresholds to determine, for example if the texture indicates is “high” or other conditions are present to indicate a high texture, the bit rate is “high”, a scene change has occurred, a whether motion vectors indicate a “large” or “small” magnitude, etc. In the alternative, one or more of the non-quantization coding parameters 90 can be implemented via flags, status bits or other logic variables that indicate directly, via unique values, the various conditions of each parameter.

While the deblocking filter parameters 45 are selected as shown based on five different non-quantization coding parameters 90 a greater or fewer number of non-quantization coding parameters 90 can likewise be employed.

FIG. 7 presents a block flow diagram of a video encoding operation in accordance with an embodiment of the present invention. An example video encoding operation is shown includes an in-line deblocking filter module 222, such as video filter 102. Motion search module 204 generates a motion search motion vector for each macroblock of a plurality of macroblocks based on a current frame/field 260 and one or more reference frames/fields 262. Motion refinement module 206 generates a refined motion vector for each macroblock of the plurality of macroblocks, based on the motion search motion vector. Intra-prediction module 210 evaluates and chooses a best intra prediction mode for each macroblock of the plurality of macroblocks. Mode decision module 212 determines a final motion vector for each macroblock of the plurality of macroblocks based on costs associated with the refined motion vector, and the best intra prediction mode.

Reconstruction module 214 generates residual pixel values corresponding to the final motion vector for each macroblock of the plurality of macroblocks by subtraction from the pixel values of the current frame/field 260 by difference circuit 282 and generates unfiltered reconstructed frames/fields by re-adding residual pixel values (processed through transform and quantization module 220) using adding circuit 284. The transform and quantization module 220 transforms and quantizes the residual pixel values in transform module 270 and quantization module 272 and re-forms residual pixel values by inverse transforming and dequantization in inverse transform module 276 and dequantization module 274. In addition, the quantized and transformed residual pixel values are reordered by reordering module 278 and entropy encoded by entropy encoding module 280 of entropy coding/reordering module 216 to form network abstraction layer output 281.

Deblocking filter module 222 forms the current reconstructed frames/fields 264 from the unfiltered reconstructed frames/fields and further based on non-quantization coding parameters 90 generated by one or more of the modules 204, 206, 210, 212, 214, 216 or 220 or via additional post-processing via a dedicated or shared processing device (not expressly shown). It should also be noted that current reconstructed frames/fields 264 can be buffered to generate reference frames/fields 262 for future current frames/fields 260.

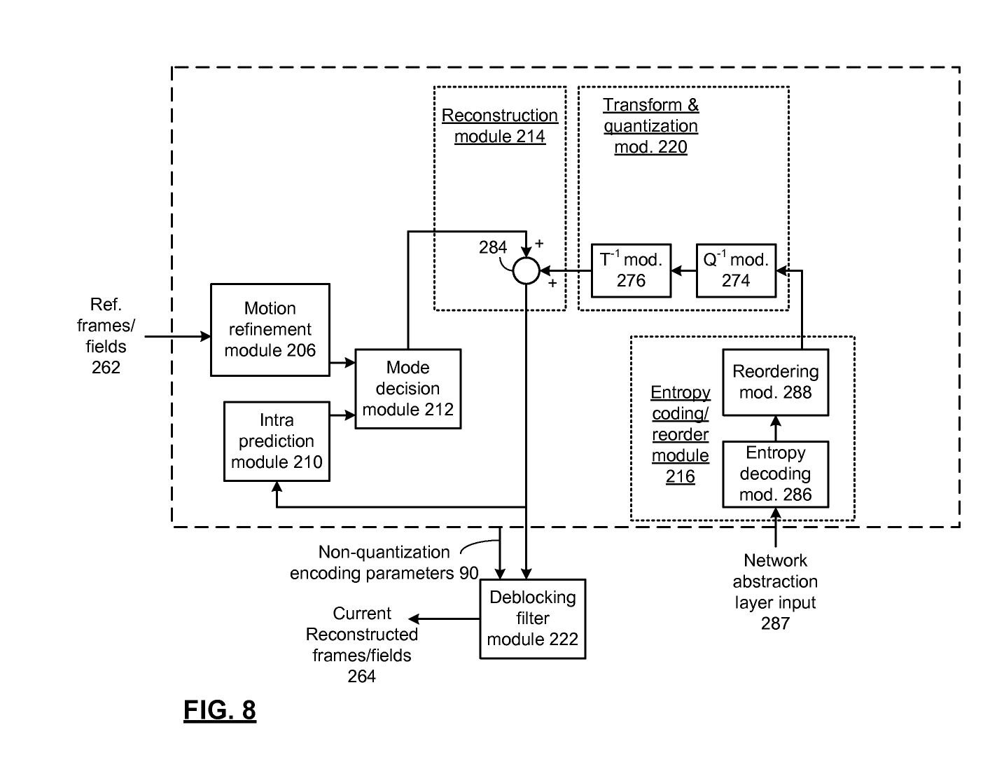

One or more of the modules of shown herein—including the deblocking filter module 222, can also be used in the decoding process as will be described further in conjunction with FIG. 8.

FIG. 8 presents a block flow diagram of a video decoding operation in accordance with an embodiment of the present invention. In particular, this video decoding operation contains many common elements described in conjunction with FIG. 7 that are referred to by common reference numerals. In this case, the motion refinement module 206, the intra-prediction module 210, the mode decision module 212, and the deblocking filter module 222 are each used as described in conjunction with FIG. 7 to process reference frames/fields 262. In addition, the reconstruction module 214 reuses the adding circuit 284 and the transform and quantization module reuses the inverse transform module 276 and the inverse quantization module 274. In should be noted that while entropy coding/reorder module 216 is reused, instead of reordering module 278 and entropy encoding module 280 producing the network abstraction layer output 281, network abstraction layer input 287 is processed by entropy decoding module 286 and reordering module 288.

It should be noted, that while FIGS. 7 and 8 discuss the use of an adaptive deblocking filter, such as video filter 102 in conjunction with encoding and decoding operations, such an adaptive deblocking filter can likewise be employed in transcoding operations and in other video processing operations.

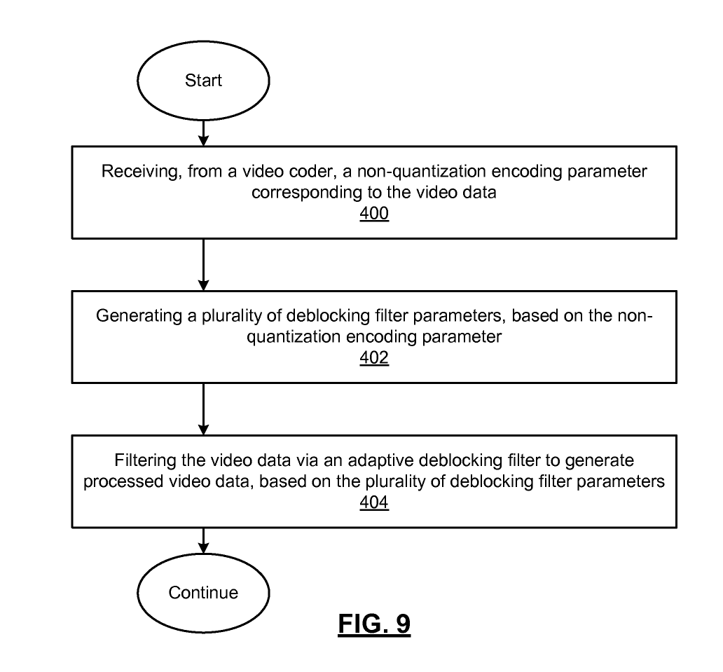

FIG. 9 presents a flowchart representation of a method in accordance with an embodiment of the present invention. In particular, a method is presented for use in conjunction with one or more functions and features presented in conjunction with FIGS. 1-8. In step 400, a non-quantization coding parameter corresponding to the video data is receiving from a video coder, such as a encoder, decoder or transcoder. In step 402, a plurality of deblocking filter parameters are generated, based on the non-quantization coding parameter. In step 404, the video data are filtered via an adaptive deblocking filter to generate processed video data, based on the plurality of deblocking filter parameters.

In an embodiment of the present invention, the plurality of deblocking filter parameters includes a boundary edge threshold and an interior edge threshold. The non-quantization coding parameter can include a picture type indicator, a motion vector magnitude, a scene change indicator, a bit rate indicator and/or a high texture indicator.

While particular combinations of various functions and features of the present invention have been expressly described herein, other combinations of these features and functions are possible that are not limited by the particular examples disclosed herein are expressly incorporated in within the scope of the present invention.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As the term module is used in the description of the various embodiments of the present invention, a module includes a functional block that is implemented in hardware, software, and/or firmware that performs one or module functions such as the processing of an input signal to produce an output signal. As used herein, a module may contain submodules that themselves are modules.

Thus, there has been described herein an apparatus and method, as well as several embodiments including a preferred embodiment, for implementing a video processing device, a video encoder/decoder and deblocking filter module for use therewith. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A video filter that processes video data, the video filter comprising:
a filter parameter generator, that receives a non-quantization coding parameter corresponding to the video data and that generates a plurality of deblocking filter parameters in response thereto; and
an adaptive deblocking filter, coupled to the filter parameter generator, that filters the video data to generate processed video data, based on the plurality of deblocking filter parameters.

2. The video filter of claim 1 wherein the plurality of deblocking filter parameters includes a boundary edge threshold and an interior edge threshold.

3. The video filter of claim 1 wherein the non-quantization coding parameter includes a picture type indicator.

4. The video filter of claim 1 wherein the non-quantization coding parameter includes a motion vector magnitude.

5. The video filter of claim 1 wherein the non-quantization coding parameter includes a scene change indicator.

6. The video filter of claim 1 wherein the non-quantization coding parameter includes a bit rate indicator.

7. The video filter of claim 1 wherein the non-quantization coding parameter includes a high texture indicator.

8. A method for use in a video filter that processes video data, the method comprising:
receiving, from a video coder, a nonquantization coding parameter corresponding to the video data;
generating a plurality of deblocking filter parameters, based on the non-quantization coding parameter; and
filtering the video data via an adaptive deblocking filter to generate processed video data, based on the plurality of deblocking filter parameters.

9. The method of claim 8 wherein the plurality of deblocking filter parameters includes a boundary edge threshold and an interior edge threshold.

10. The method of claim 8 wherein the non-quantization coding parameter includes a picture type indicator.

11. The method of claim 8 wherein the non-quantization coding parameter includes a motion vector magnitude.

12. The method of claim 8 wherein the non-quantization coding parameter includes a scene change indicator.

13. The method of claim 8 wherein the non-quantization coding parameter includes a bit rate indicator.

14. The method of claim 8 wherein the non-quantization coding parameter includes a high texture indicator.

15. A video filter that processes video data, the video filter comprising:
a filter parameter generator, that receives a non-quantization coding parameter corresponding to the video data and that generates a plurality of deblocking filter parameters in response thereto, wherein the plurality of deblocking filter parameters includes a boundary edge threshold and an interior edge threshold; and
an adaptive deblocking filter, coupled to the filter parameter generator, that filters the video data to generate processed video data, based on the plurality of deblocking filter parameters, wherein the non-quantization coding parameter includes at least one of:
a picture type indicator;
a motion vector magnitude;
a scene change indicator;
a bit rate indicator; and
a high texture indicator.
